(19) United States
(12) Patent Application Publication
(10) Pub. No.: US 2008/0065732 A1
(43) Pub. Date: Mar. 13, 2008

(54) Referral instant messaging

(75) Inventors: Kiran Kulkarni, Mumbai (IN); Vinay V, Mumbai (IN)

Correspondence Address: Ashok Tankha;Lipton, Weinberger & Husick, 36 Greenleigh Drive, Sewell, NJ, 08080, US

(73) Assignee: Geodesic Information Systems Ltd, Mumbai (IN)

(21) Appl. No.: 11/801,285

(22) Filed: May 9, 2007

(30) Foreign Application Priority Data
Sep. 13, 2006 (IN) 1671/CHE/2006

(51) Int. Cl. G06F 15/16

(52) U.S. Cl. 709/206

(57) ABSTRACT

A referral instant messenger link is provided on the webpage of the host website. By clicking the link, a user interface opens up that requests for authentication. Multiple instant messenger accounts of a plurality of instant messenger vendors are displayed within the user interface. The reader can choose a contact and send the universal resource locator address of the website that is currently viewed by a single click provided within the user interface. This facility eliminates the need of the reader leaving the host website in order to pursue instant messaging to send the link to his contacts. This also enables the webmaster of the host website to insert advertising material as appropriate. The web page reader does not have to download and install any new software on his or her computer for accessing the referral instant messenger (RIM).

### BACKGROUND

This invention in general relates to information technology and specifically refers to the referral of webpages via instant messaging.

The success of consumer services on the internet depends on the user face-time, i.e., the amount of time a user spends at a website. The factors contributing to this metric are total user-base and average usage. Internet businesses recognize the value of building communities around their online content and services in order to increase this metric. Arguably, the task of building and growing online communities is more challenging than knowing exactly how to monetize this community.

The most effective way of building an on-line community and extending the reach of an online brand is viral marketing. Viral marketing is characterized by existing users of an internet service intentionally or unintentionally telling their friends about the service, thus forming a large community of sales persons spreading the word electronically at internet speed. It is important to note that such communication on the Web has largely been restricted to e-mail.

In the year 2006, between AOL Instant Messenger (AIM) of America Online Inc. USA, I seek you (ICQ) of ICQ Inc. USA, Microsoft Network (MSN), of Microsoft Corporation, Yahoo of Yahoo Inc. USA, there are 342 million unique users with 867 million user accounts. With the user base of Google Talk of Google Inc. USA, and Skype of Skype Limited, this number would be a larger. On average, an instant messenger (IM) user has 2.3 accounts, and 11.6 buddies per service. These buddies are trusted friends and family that users interact with on a regular basis. Public IM networks form a large, connected, and active network of people online. Despite these characteristics, not many internet businesses have been able to effectively tap into this network of people for viral marketing of their brands.

Online advertisements are an important and growing source of income for media based companies. The success of online advertisements depends on the success of viral marketing methods. In order to invite online traffic to their websites, some of the news channel host websites provide an option “e-mail this link” on their websites, with the objective of inviting a large number readers to their website. However, this option has its drawbacks. The e-mail facility does not provide a means of having a real time interactive chat conversation on the topic of interest of the website.

In order to enable real time discussions on the topic of interest, the reader can simply click on their instant messenger icon, login into instant messenger, look up their friends, cut and paste the link of interest and send it via instant messenger to their friends. This method too has its drawbacks. First, the reader may have multiple instant messenger accounts, and their contacts may be distributed across all these accounts. This forces the reader to open up and sign into all these instant messenger accounts. Secondly, even if the readers opens up multiple accounts, and if two or more contacts are of different instant messenger accounts, for example if one reader is a Yahoo IM (of Yahoo Inc. USA) user and the other is a AOL IM (of America Online Inc. USA) user, the live discussions are in multiple windows and are not necessarily collaborative. Third, and most importantly, it is assumed that the computer of the reader has the instant messenger program installed. For example, the user may be operating someone else's computer that does not have the instant messenger programs such as those of Yahoo IM and AOL IM installed. Fourth, even if a reader copies the universal resource locator (URL) link of the website they are reading and instant messages to a contact, the contact may open the link, but there is little control on which website is being viewed by the contact. For example, the contact may have a quick look at the website and then close it out and continue to have an instant messenger discussion with the user on a different subject.

Hence, there is an unmet market need for a method and system for sharing website information, where readers of a plurality of multiple instant messenger accounts can collaboratively discuss the subject of interest on a website, and where all instant messenger accounts need not be necessarily installed on the reader's computer, and the host website ensures that while the instant messenger discussions take place, the reader and their contact friends continue to be within the environment of the host website.

### SUMMARY OF THE INVENTION

The method and system disclosed herein enables readers of a plurality of multiple instant messenger (IM) accounts to collaboratively discuss the subject of interest on a website, without the necessity for instant messenger to be installed on the readers computer, and allows the host website to introduce advertisements in the instant messenger window and while the instant messenger discussions take place, the reader and their contact friends continue to view the host website, whereby the host website ensures that the reader and their contacts spend more time at their website. This results in an improved reading experience, generates more website traffic, increases site registrations and provides a new channel of advertising for the host website.

The method and system disclosed herein called referral instant messenger (RIM) enables the transmission of a universal resource locator address of a web page of a host website from one reader to one or more contacts of the reader. A RIM link is provided on the webpage of the host website. The reader requests for authentication by clicking the link and providing username(s) and password(s) of the instant messenger (IM) accounts. The access to a list of instant messenger contacts of the reader is provided upon successful authentication reader. The list of contacts and their status is displayed in a user interface component. The reader can choose one or more contacts and send the Universal Resource Locator (URL) address of the web page that is currently viewed. This process eliminates the need of the reader leaving the host website in order to pursue instant messaging to send the link to his contacts. This also enables the webmaster of the host website to insert advertising material in the user interface component. In order to access the referral instant messenger (RIM), the web page reader does not have to download and install any new software on his or her computer. The method and system of this invention is independent of the operating system and browser platforms of the reader's computer. A conversation interface is provided within the user interface component for the purpose of exchanging messages between the reader and one or more selected contacts.

### BRIEF DESCRIPTION OF THE DRAWINGS

FIG. 1 illustrates a method of referring websites.

FIG. 2 illustrates the system that enables website referrals.

FIG. 3A exemplarily illustrates a screen shot of a host website with the RIM link.

FIG. 3B exemplarily illustrates a screen shot of a host website with the floating window requesting authentication.

FIG. 4 exemplarily illustrates a screen shot of the host website after the reader logs in.

FIG. 5 exemplarily illustrates a screen shot of the message received at the contact's computer.

FIG. 6 exemplarily illustrates a screen shot of recipient selection and message broadcast page.

FIG. 7 exemplarily illustrates a screen shot of the host website with a floating window that contains the chat correspondences.

FIG. 8 A illustrates an example XML message format for a login message.

FIG. 8 B illustrates an example XML message format for a login response.

FIG. 8 C illustrates an example XML message format for a send message request.

FIG. 8 D illustrates an example XML message format for a send message response.

### DETAILED DESCRIPTION OF THE INVENTION

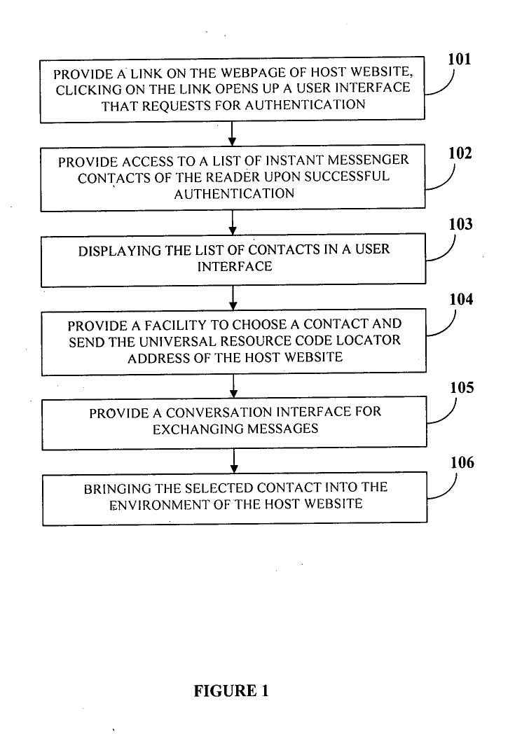

FIG. 1 illustrates a method of referring websites. A RIM link is provided on the webpage of the host website. The reader clicks on the link that results in a request for authentication of the user to his or IM her networks 101. The readers access their list of instant messenger contacts upon successful authentication, for example through input of username and password 102. The list of contacts along with their status is displayed in a user interface component 103. The reader can choose one or more contacts and send the URL of the web page that is currently viewed 104. This process eliminates the need of the reader leaving the host website in order to pursue instant messaging to send the link to his contacts. This also enables the webmaster of the host website to insert advertising material as appropriate. A conversation interface is provided for the purpose of exchanging messages between the reader and one or more selected contacts 105. The web page of the host website is opened along with the conversation interface on the computer of a selected contact. When the selected contact clicks on the sent universal resource code locator address, the selected contact is brought into the environment of the host website along with the user interface component 106.

The reader does not have to download and install any new software on his or her computer for accessing the referral instant messenger (RIM). The method and system of this invention is independent of the operating system and browser platforms of the reader's computer. This convenience is a significant factor in increasing the numbers of readers of this referral service. When a reader's contact clicks on the link sent by the reader, the reader will be re-directed to the same web page, enabling the contact to forward the web page to his IM contacts.

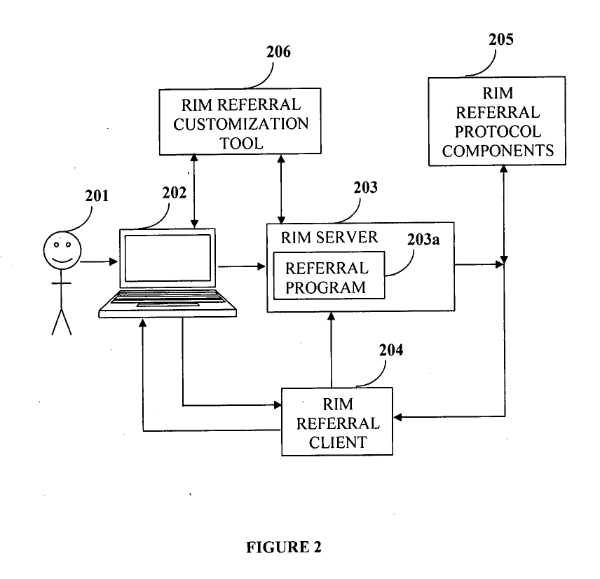

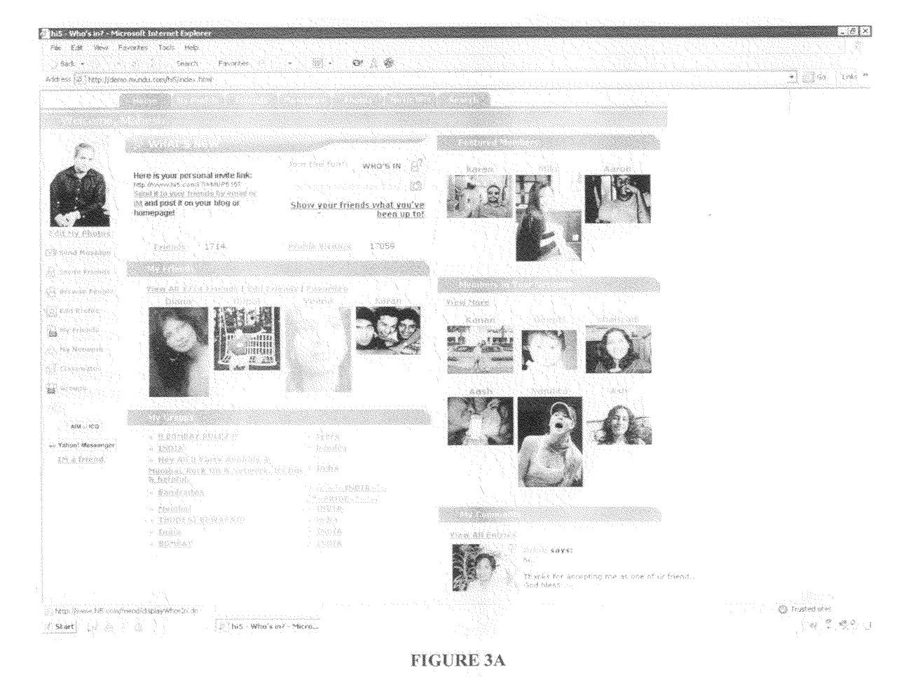

FIG. 2 illustrates the system that enables the referral of websites. The RIM system comprises of a computer 202 (i.e. the reader's computer), RIM referral client 204, RIM referral server 203, RIM referral protocol components 205 and RIM referral customization tool 206.

The words “contacts” and “buddies” are interchangeably used in the description.

Consider a webpage that the reader wishes to share with friends. The reader 201 clicks a RIM link displayed on the content page using a computer 202. The RIM referral client 204 then connects to the RIM referral server 203 and brings up the login page. If the reader 201 is already logged in, a list of contacts, i.e. buddies is shown to the reader 201. If the reader 201 is not already logged in, the RIM referral client 204 asks the user for authentication to the user's IM accounts. The reader 201 enters one or more ids and passwords of his or her IM account(s). 201. The RIM referral client 204 encapsulates the reader's credentials and sends it to the RIM Server 205. The RIM server 203 authenticates access to the multiple IM networks as specified by the reader 201. The RIM server 203 sends a cookie to the RIM referral client 204 if required, along with the response to the login request. The response contains the IM contact list of the reader, provided the reader was successfully authenticated. 201. This list is displayed to the reader 201, allowing the reader 201 to choose the contact(s) to whom the weblink is to be sent. The reader 201 selects the contacts and optionally types a message. The list of chosen contacts and the message is sent by the RIM referral client 204 to the RIM server 203. The RIM server 203 sends the message to the user's specified contacts along with the URL of the web page. A status indicating success/failure is sent to the RIM referral client 204, which displays the same to the reader. The RIM referral client 204 offers the user the option to log off from the RIM service.

The RIM referral client 204 is operable with a plurality of browsers, including but not restricted to work with Firefox 1.5 or above versions, Microsoft internet explorer version.6 (MS IE 6) or above versions, as well as the Opera browser. The RIM system allows for customization of the look and feel in order to make it suitable for integration with various web-sites.

The framework is designed in such a way so as to easily allow the quick addition of any new IM protocol components.

The referral protocol component 205 provides the protocol for communication between the referral program 203a and said plurality of instant messenger vendors. The RIM referral protocol components 205 may comprise of but is not restricted to the Yahoo protocol component, MSN protocol component, AIM protocol component and Google talk.

RIM referral customization tool is for interfacing the user with the RIM referral instant messenger.

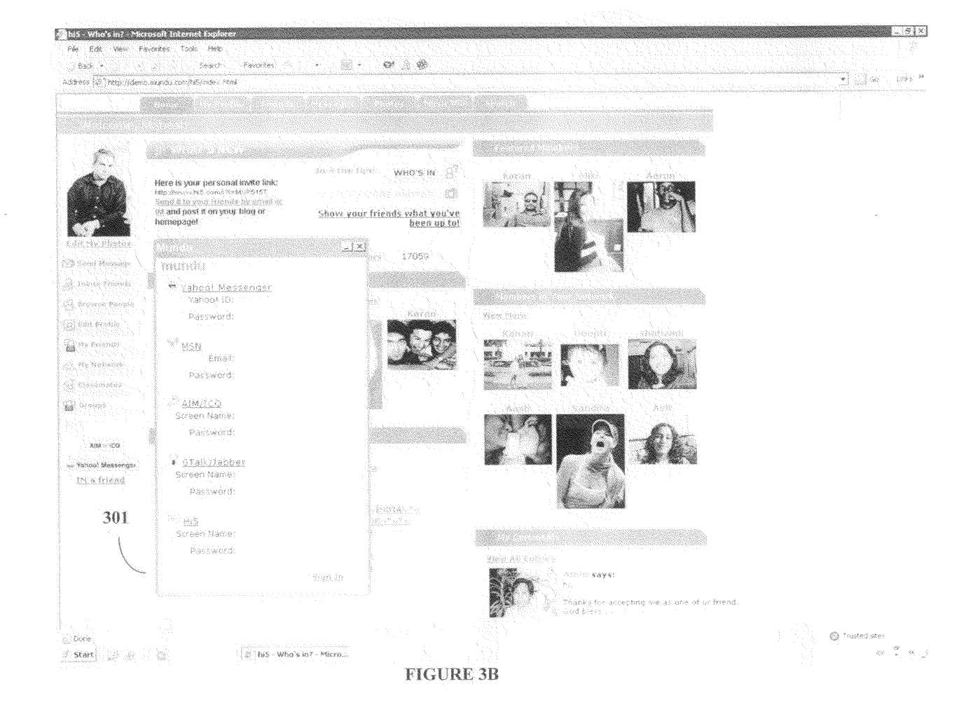

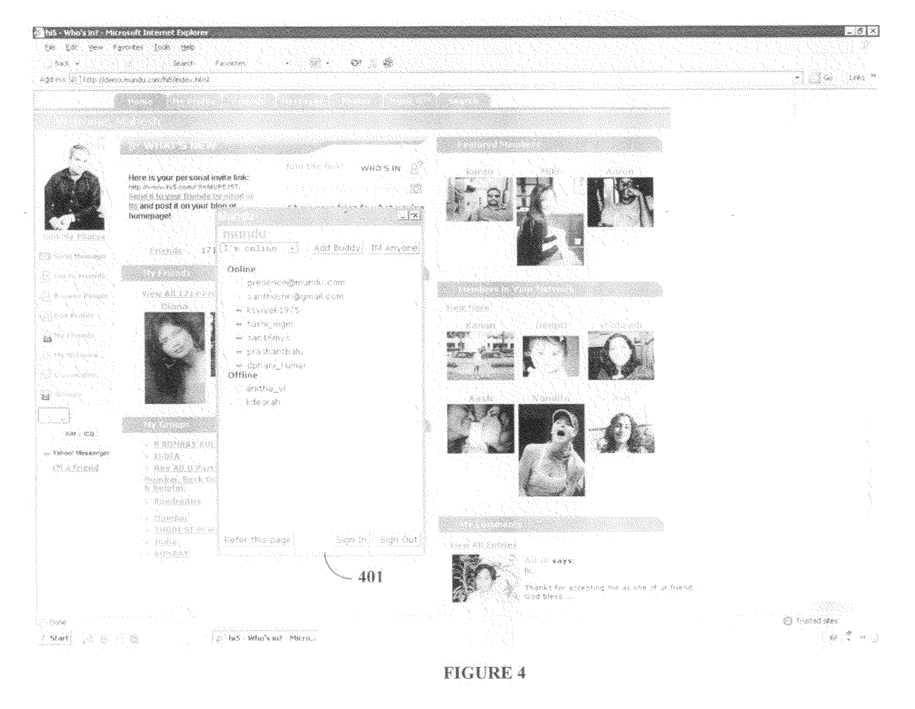

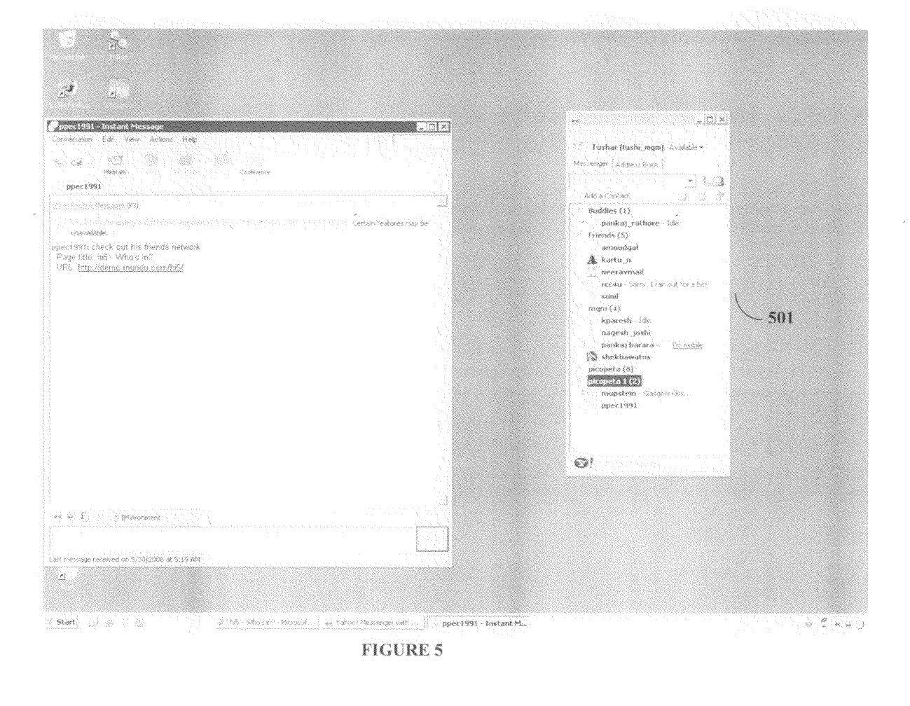

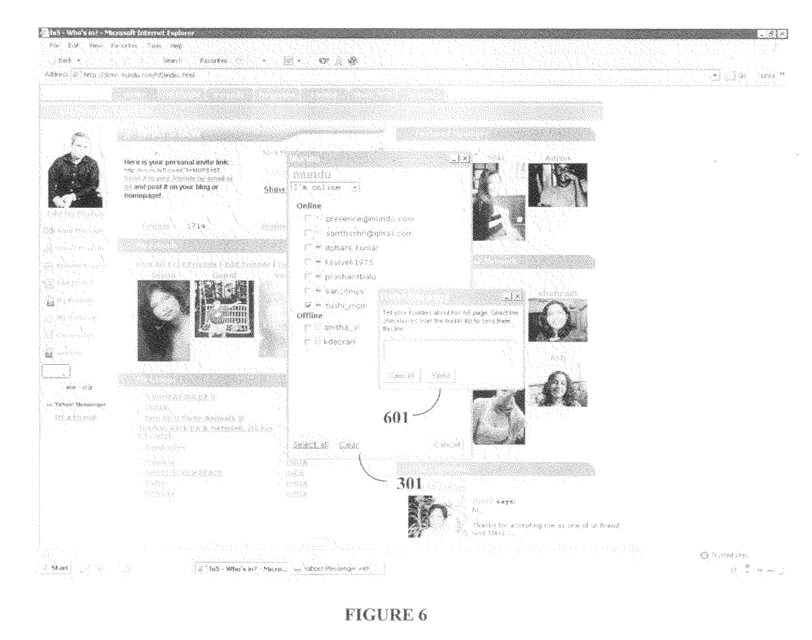

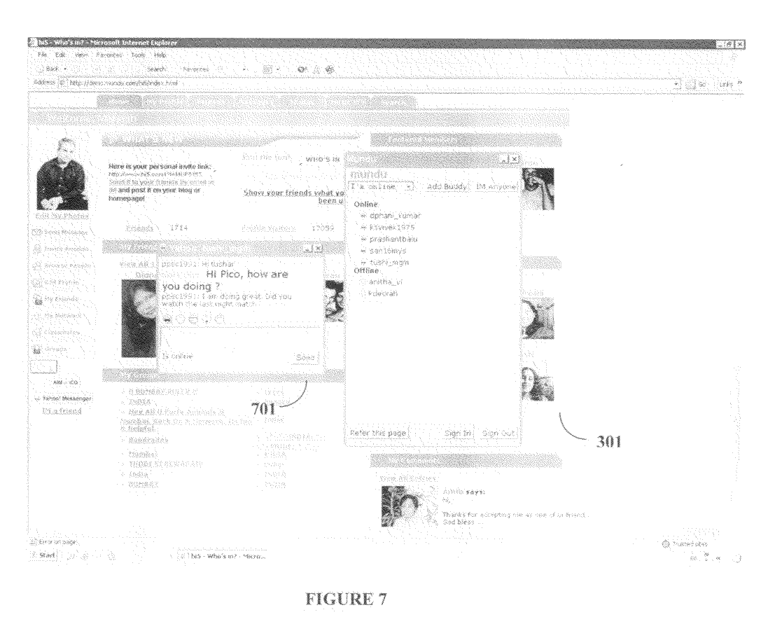

FIG. 3A, FIG. 3B, FIG. 4, FIG. 5, FIG. 6 and FIG. 7 illustrate an example of the method and system of this invention. One embodiment of the invention describes the user interface component as floating window.

FIG. 3A exemplarily illustrates a screen shot of a host website with the RIM link. The reader John Smith is reading a news page on CNN.com, when he comes across an item which he would like to share with his friends/colleagues. He spots the “IM a friend” link on the content page and clicks on it. The RIM referral client 204 connects to the RIM referral server 203 and gets the login page. If John is already logged in, he is shown the list of his IM contacts. The RIM referral client 204 opens a small floating window 301 with the login page, as illustrated in FIG. 3B. The floating window 301 opened is not a pop up window, however it is a floating window 301 within the same browser. John enters his user-id and password in text boxes provided to him, for all the IM services used by him and clicks on the “Sign-in” link or presses “Enter”.

The RIM referral client 204 encapsulates the John's credentials and sends it to the RIM server 203. The RIM server 203 authenticates to the various IM networks that John has subscribed to. The RIM server 203 sends the login response message that contains the buddy list of the reader. The RIM referral client 204 receives the buddy list and displays the same to the reader, allowing him an option of ticking the contacts to whom he wants to send the message, as well the message he wants to send.

FIG. 4 exemplarily illustrates a screen shot of the host website after the reader logs in. The reader selects the contacts and types a message. RIM referral client 204 sends the list of contacts 401 and the message to the server. The RIM server 205 sends the message specified by the reader to all the contacts selected by the reader. The RIM server 205 responds to the client with the status information.

FIG. 5 exemplarily illustrates a screen shot of the message received at the contact's computer. The reader may choose to keep the window open. When the floating window 301 is open, the reader can see the status notifications for the message 501. The reader may choose to close the window, in which case he does not see the status of messages.

FIG. 6 exemplarily illustrates a screen shot of the recipient selection 601 and message broadcast page.

FIG. 7 exemplarily illustrates a screen shot of the host website with a floating window 301 that contains chat correspondences. As displayed, the host website can insert promotional information in the messaging window 701. The subject of the information inserted by the host of the website can be defined by the subject of the news feature being discussed by the reader with the contact. The client displays to the reader that the messages were successfully sent. The Reader clicks on the “Sign-out” button. The RIM referral client once again displays the initial login screen. When the reader clicks on the X (close) button, the window is closed.

The revenue model of the RIM referral customization tool 206 provider is based on the usage of the instant messaging system. The usage tracking involves the tracking of metrics of the reader and tracking of metrics of the system. The elements considered to track the reader is not restricted to but consists of total referrals sent, total unique readers to whom referrals sent, total click-through by selected contacts and the conversion rate, resulting action in the session where click-through happens for registration, collaboration, advertising, e-commerce, reader who sends highest referrals, reader who receives highest chat requests, reader who affects highest conversions. The elements considered to track metrics is not restricted to but consists of total referrals sent per public instant message, time-stamp of each referral, therefore total referrals sent per time unit, total referrals that could not be sent due to system failure, system success rate in sending referrals per public instant message, time-stamp of each click-through, therefore total click-throughs per time unit.

A profile of the activities that occurred as a result of the referral is stored and sent to the host. The effectiveness of referrals is also determined. For example, if ten referrals were made, it is determined as to how many contacts actually came to the site, and how many contacts actually became registered users. The host site can then decide on what people typically refer. For example, sports based referrals might bring in more new readers or referred readers than politics based referrals.

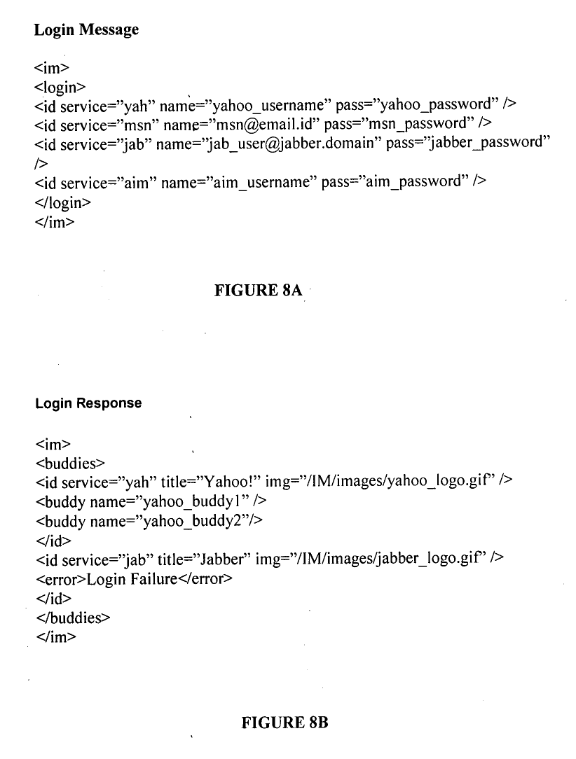

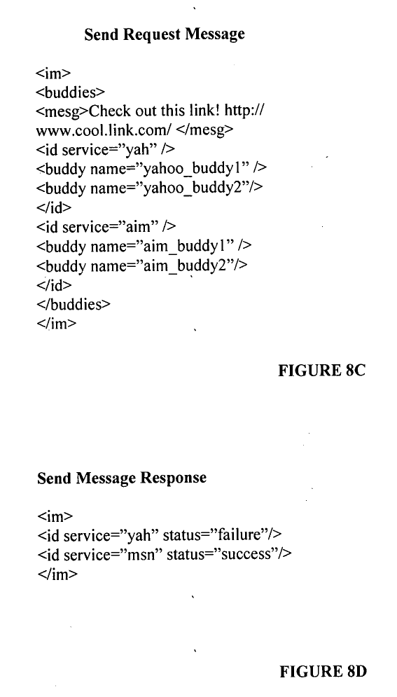

FIG. 8A-8B illustrates a XML message format used to communicate between the RIM referral client and the RIM server. The communication between the RIM referral client and the RIM server is through four different messages namely login message, login response, send message request and send message response.

FIG. 8 A illustrates an example XML message format for a login message. The RIM referral client sends the request to the RIM server and expects a response from it. The message is sent from the RIM referral client to the RIM server.

FIG. 8 B illustrates an example XML message format for a login response. The login response is generated by the RIM server. For all IM services, where authentication was successful, the contact list is returned. The XML is not directly sent to the client, but is transformed using an XSL before sending to the RIM referral client.

FIG. 8 C illustrates an example XML message format for send message request. The send message request is sent from the RIM referral client to the RIM server. It includes a list of the reader's contacts to which the message must be sent, as well as the message to be sent.

FIG. 8 D illustrates an example XML message format for send message response. The send message response is generated by the RIM server to inform the client of the status of the message that is to be sent to a list of the reader's contacts.

We claim:

1. A method of transmitting a universal resource code locator address of a webpage of a host website from one reader to one or more contacts of said reader, comprising the steps of:
providing a link on the webpage of host website, wherein clicking on said link opens up a user interface component that requests for authentication;
providing access to a list of instant messenger contacts of the reader upon successful authentication of the reader, displaying in the user interface component multiple instant messenger accounts of a plurality of instant messenger vendors and the list of the reader's contacts;
providing within the user interface component a facility to choose a contact and send the universal resource code locator address, whereby eliminating the need of the reader to leave the host website in order to pursue instant messaging to send the link to the reader's contacts;
providing a conversation interface within the user interface component for the purpose of exchanging messages between the reader and one or more selected contacts;
opening said webpage of the host website along with said conversation interface on the computer of a selected contact when the selected contacts clicks on said sent universal resource code locator address, whereby the selected contact is brought into the environment of the host website with the user interface component; and
whereby a program is available on demand on a server of the host website and is executed on the reader's computer and the program is not required to be downloaded and installed for providing said link and user interface component.

2. A system for transmitting a universal resource code locator address of a webpage of a host website from one reader to one or more contacts of said reader, comprising:
a referral client that manifests as a link on the webpage of said host website, that provides:
a link on the webpage of host website, wherein clicking on said link opens up a user interface component that requests for authentication;
access to a list of instant messenger contacts of the reader upon successful authentication, displaying in the user interface multiple instant messenger accounts of a plurality of instant messenger vendors and the list of the reader's contacts;
a facility within the user interface to choose a contact, whereby eliminating the need of the reader to leave the host website in order to pursue instant messaging to send the link to the reader's contacts; and
a conversation interface within the user interface for the purpose of exchanging messages between the reader and one or more selected contacts.
a referral program located on a server of the host, that is downloaded on demand and executed on the client machine, wherein the referral program is in communication with the referral client that manages and executes the sign in authentication to the plurality of instant messenger vendors;
a referral customization tool;
a referral server that accepts and authenticates sign in requests from the reader; and
a referral protocol component that provides the protocol for communication between said referral program and said plurality of instant messenger vendors.

3. The method of claim 1, wherein the host website can store information on the messaging activity that occurs as a result of a referral, wherein the messaging activity includes the number of referrals sent and the number of accepted referrals.

4. The method of claim 1, wherein the host website can insert advertising information within the user interface.

5. The method of claim 1, wherein when the reader chooses to continue with the instant messaging system, the reader gets a notification about the status of the instant message.

6. The method of claim 1, wherein the messaging related reader and contact activities are tracked.

7. The method of claim 1, wherein the user interface is a user interface component.

8. The method of claim 7, wherein the tracking metrics of the reader is inclusive of but not restricted to total referrals sent, total unique readers to whom referrals were sent, total click-through by selected contacts and their conversion rate, collaboration, advertising, e-commerce, reader who sends the highest number of referrals, reader who receives the highest chat requests and readers who affects highest conversions.

9. The method of claim 7, wherein tracking metrics of the system is inclusive of but not restricted to total referrals sent per public instant message, time-stamp of each referral, total referrals that could not be sent due to system failure, system success rate in sending referrals per public instant message and time-stamp of each click-through.
